(19) United States
(12) Patent Application Publication
(10) Pub. No.: US 2004/0210468 A1
(43) Pub. Date: Oct. 21, 2004

(54) System and method for providing a territory management tool

(76) Inventors: Ralf Rubel, Gaggenau (DE); Frank Mathes, Annweiler (DE)

Correspondence Address: KENYON & KENYON, 1500 K STREET, N.W., SUITE 700, WASHINGTON, DC, 20005, US

(21) Appl. No.: 10/636,618

(22) Filed: Aug. 8, 2003

Related U.S. Application Data
(60) Provisional application No. 60/463,733, filed on Apr. 18, 2003.

(51) Int. Cl. G06F 17/60

(52) U.S. Cl. 705/8

(57) ABSTRACT

Embodiments of the present invention provide a system and method of managing a plurality of sales territories. In one embodiment, leaf nodes may be associated with sales territories such that each leaf node is associated with one of the sales territories. The leaf nodes may be located in a hierarchy of nodes. Each higher node in the hierarchy may be associated with at least one of the leaf nodes and may represent the sales territory of such leaf node. A first attribute may be associated with a first one of the leaf nodes. The first attribute may relate to the sales territory that is associated with the first leaf node. A second attribute and a request to identify a sales territory that is associated with the second attribute may be received. The leaf nodes may be searched for the second attribute without inheriting attributes from the higher nodes in the hierarchy. The sales territory associated with a leaf node having the second attribute may be identified.

### RELATED PATENT APPLICATION

This patent application claims benefit of U.S. Provisional Patent Application Serial No. 60/463,733 filed Apr. 18, 2003.

### TECHNICAL FIELD

The present invention relates to a territory management tool. In particular, embodiments of the present invention provide a system and method for the management of service and/or sales territories.

### BACKGROUND OF THE INVENTION

Companies sometimes use software program applications to model sales organizations and to assist with the management of territories. One example of such an application models sales territories as items in a tree structure having parent/child relationships. The tree structure may form a hierarchy of items that includes a “root” item. The root item may represent the highest level in the hierarchy, and as such may not have a parent item. The root item may be associated with various child items that may represent entities at a first level, lower than the root item in the hierarchy. These first level items may in turn be parent items to second level items, which may be parent items to third level items, etc. The structure of the hierarchy of items can be stored according to these parent/child relationships between items.

Items in the hierarchy can have characteristics associated with them that describe a functionality or responsibility for the item. Conventionally, a program application for managing these items may maintain each of these characteristics in separate data tables, for each item in the hierarchy. Characteristics associated with higher items in the hierarchy can be related to lower items in the hierarchy, even though they may not be stored and maintained in association with these lower items. As such, items at lower levels in the hierarchy may inherit characteristics from their parent items. Thus, all items included in a lower level may have to be searched to identify an item by a characteristic. This dynamic characteristic inheritance step from higher-level items to lower-level items may add to the time required to perform a search on hierarchy items by characteristic. Thus, hierarchies having large numbers of items may not be practical.

Moreover, because attributes may be stored in different data tables, multiple select statements can be required for a search. In conventional systems, child items may be associated with only one parent item because of difficulties that may arise with multiple parents due to dynamic characteristic inheritance.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of a system that may utilize aspects of the invention;

FIG. 2 is a territory hierarchy in accordance with an embodiment of the invention;

FIG. 2A is a screen snapshot of a computer display in accordance with an embodiment of the invention;

FIG. 2B shows an example of a customization table in accordance with an embodiment of the present invention.

FIG. 2C shows an example of a customization table in accordance with an embodiment of the present invention.

FIG. 2D shows an example of a territory management table in accordance with an embodiment of the present invention.

FIG. 3 is a screen snapshot of a computer display in accordance with an embodiment of the invention;

FIG. 4 is a flowchart illustrating a method in accordance with an embodiment of the present invention;

FIG. 5 is a flowchart illustrating a method in accordance with an embodiment of the present invention; and

FIG. 6 is a flowchart illustrating a method in accordance with an embodiment of the present invention.

### DETAILED DESCRIPTION

Embodiments of the present invention provide a program application for customer relationship management (CRM) that may assist in managing sales, marketing, and/or other service functions. The program application may be capable of, for example, managing sales territories that can be represented as territory objects in a hierarchy of territory objects. In embodiments of the present invention, “territories” need not directly correspond to any one of the conventional organizational models that may be organized by people, geography, product or business, for example. There may be multiple and/or combination of such entities assigned to a given territory.

Embodiments of the present invention may provide faster searching capabilities since data related to the various territories may be stored in a single table configured in a flat structure. Thus, only a single table may need to be searched using one select search criteria. For example, when searching for a territory by product, the product's name may be used to search the entire hierarchical relationship.

Examples of other tasks that may be performed by the program application, in accordance with embodiments of the present invention, include describing and maintaining attributes that define responsibilities for each territory object, establishing and maintaining a structure of the territory objects in hierarchical levels, supporting time-dependent validity information associated with object attributes, conducting searches for territory objects, and/or aggregating attributes at higher levels in the hierarchy.

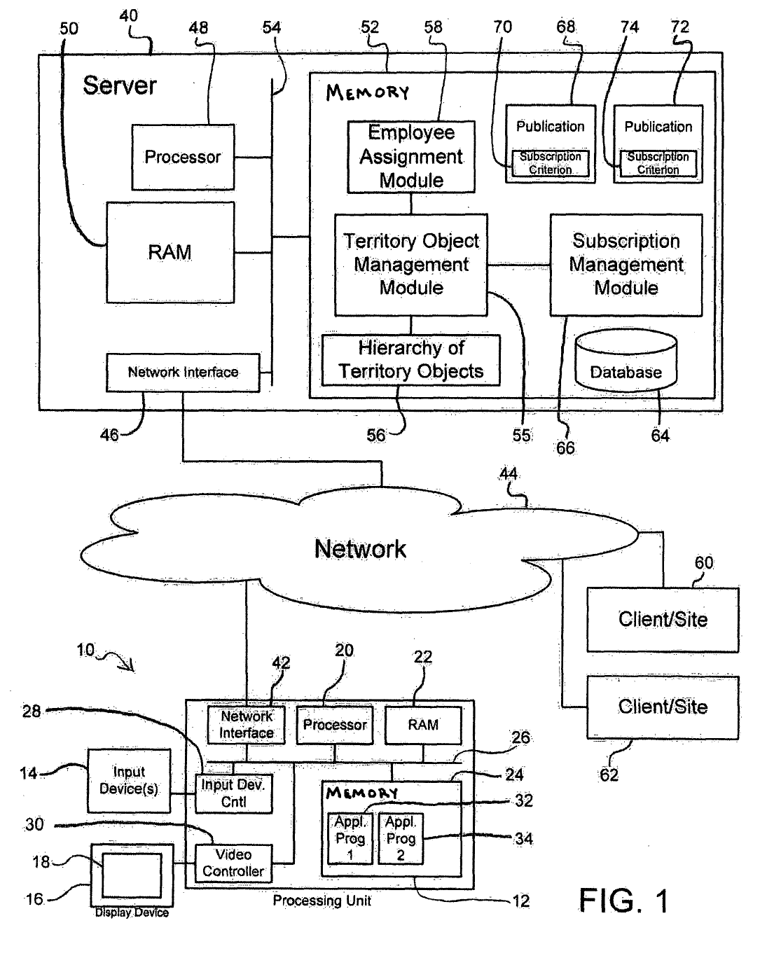

FIG. 1 is a diagram illustrating a system 100 in which embodiments of the present invention may find application. As shown, FIG. 1 may include a server 40, computer system 10, clients 60, 62 coupled to network 44. System 100 may include additional connections and/or components that are omitted from FIG. 1 for convenience.

In embodiments of the present invention, the computer system 10, shown in FIG. 1, may include a processing unit 12, one or more input devices 14, and a display device 16. The display device 16 has a video screen 18 upon which displays may appear.

The processing unit 12 may include a processor 20, random access memory (RAM) 22, network interface 42, input device controller(s) 28, video controller 30 and memory 24, all interconnected by a system bus 26. Input device controllers 28 may receive command signals from input devices 14 and forward the command signals in the appropriate format for processing. A video controller 30 may receive video command signals from the system bus 26 and generates the appropriate video signals that are forwarded to the display device 16 so that the desired display is provided on the screen 18. It is recognized that computer system 10 may include a personal digital assistant (PDA) or other handheld device, a terminal, a workstation, and/or other such device.

Memory 24 may be any type of conventional memory that provides data storage for various application programs 32, 34, etc. As is conventional, programs 32 and 34 may have program instructions that may be loaded into RAM 22 during operation. Processor 20 may execute the program instructions, as required, to perform desired program functions. Also, the components just described could be combined or separated in various manners, and could be stored in various manners, such as on various non-volatile storage medium. It is recognized that computer system 10 may include additional components that are not shown for convenience.

In embodiments of the present invention, network interface 42, included in computer system 10, may provide access to server 40 via network 44 to run applications residing on the server 40. Network 44 may be, for example, a local area network (LAN), wide area network (WAN), the Internet and/or any other type of network or combination thereof. The server 40 may include a network interface 46, one or more processors 48, RAM 50, and memory 52, all interconnected by a data bus 54. The server's network interface 46 may provide the connection to network 44. Client computer systems with access to network 44, such as systems 10, 60, and 62 shown in FIG. 1, may access server 40 using appropriate hardware and/or software. It is recognized that client computer systems 10, 60, and/or 62 may be mobile units at various sites in a sales region, for example.

The server may include memory system 52 to store a plurality of software modules and/or program instruction that may provide functionality, as described below, in accordance with embodiments of the present invention. For example, the memory system 52 may include a territory object management module 55 that can access a hierarchy of territory objects 56, which objects can be associated with sales territories. The territory object management module 55 may be able to manage tasks associated with the territory objects, as will be described later. An employee assignment module 58, also in memory system 52, may assign an employee to a sales territory (represented by a territory object) and works in conjunction with the territory object management module 55. Memory system 52 may further include a subscription management module 66 that can assign subscriptions for publications, such as publication 68 or publication 72 according to distribution rules known as subscription criteria 70 and 74, respectively. The publications may be objects that may be distributed (or replicated) over network 44.

Memory system 52, in this example, may also include data stored in database 64, although in other implementations separate databases or a separate database server may be used. The hierarchy of territory objects 56 and/or publications 68 and 72 can be stored in database 64, for example, or can alternatively be located in a separate database or storage location. It is recognized that the entities such as data, modules, etc. described above, as residing in memory system 52, could alternatively be located in a separate server, database, and/or computer system.

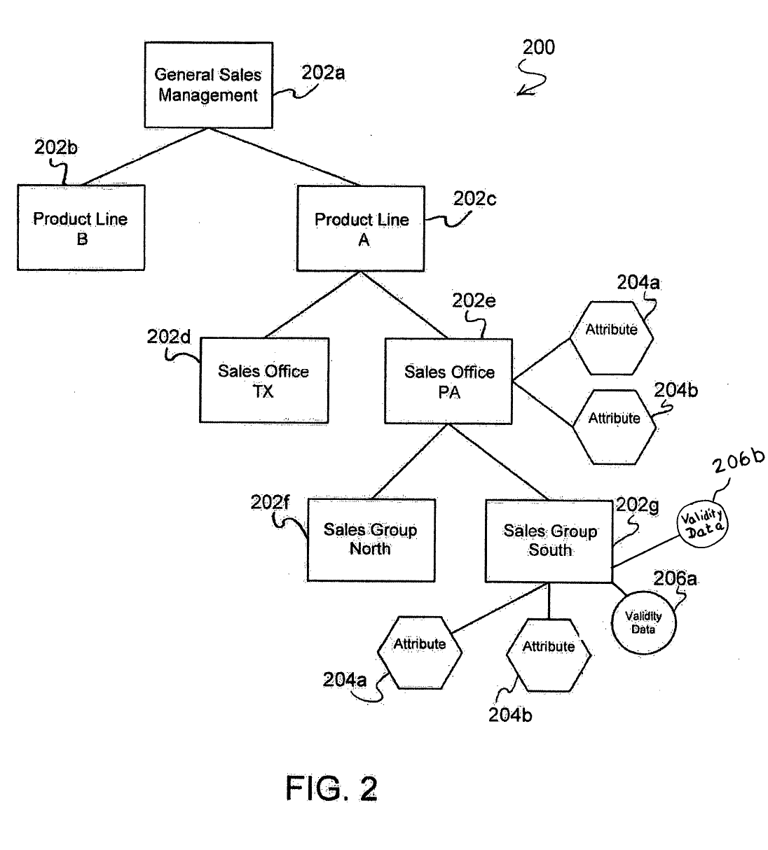

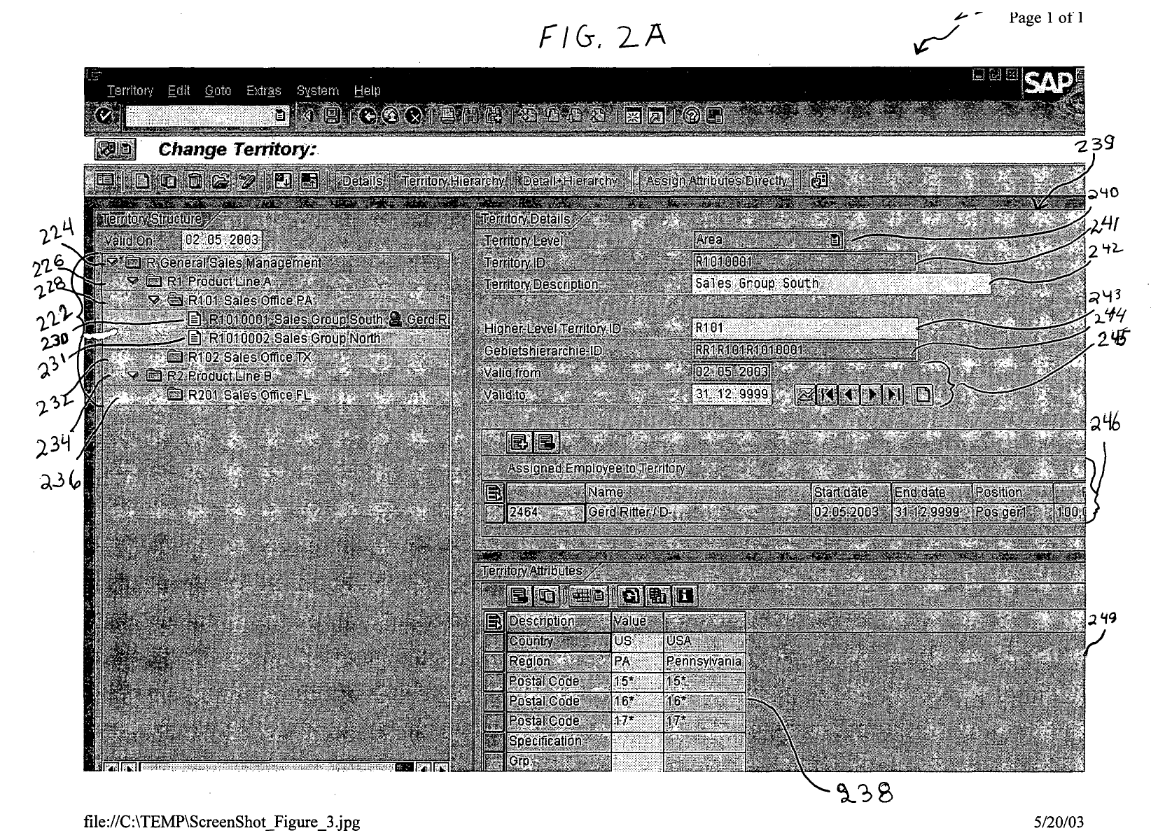

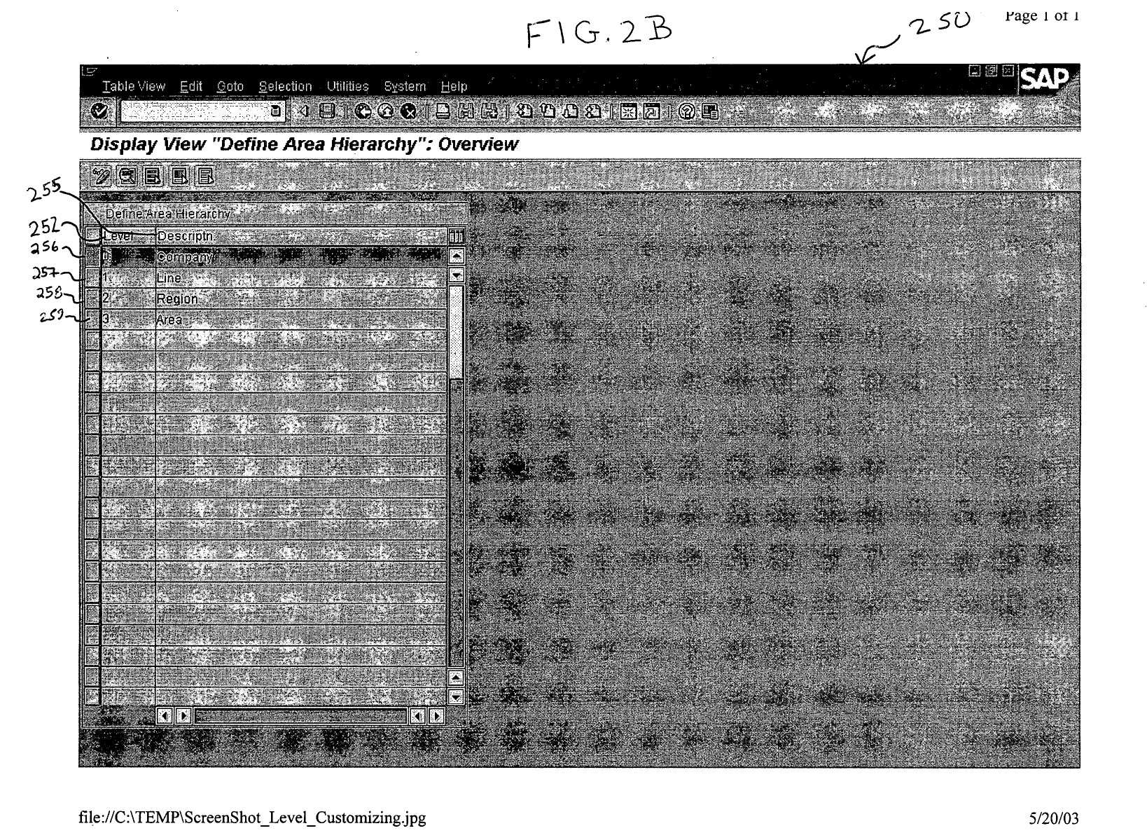

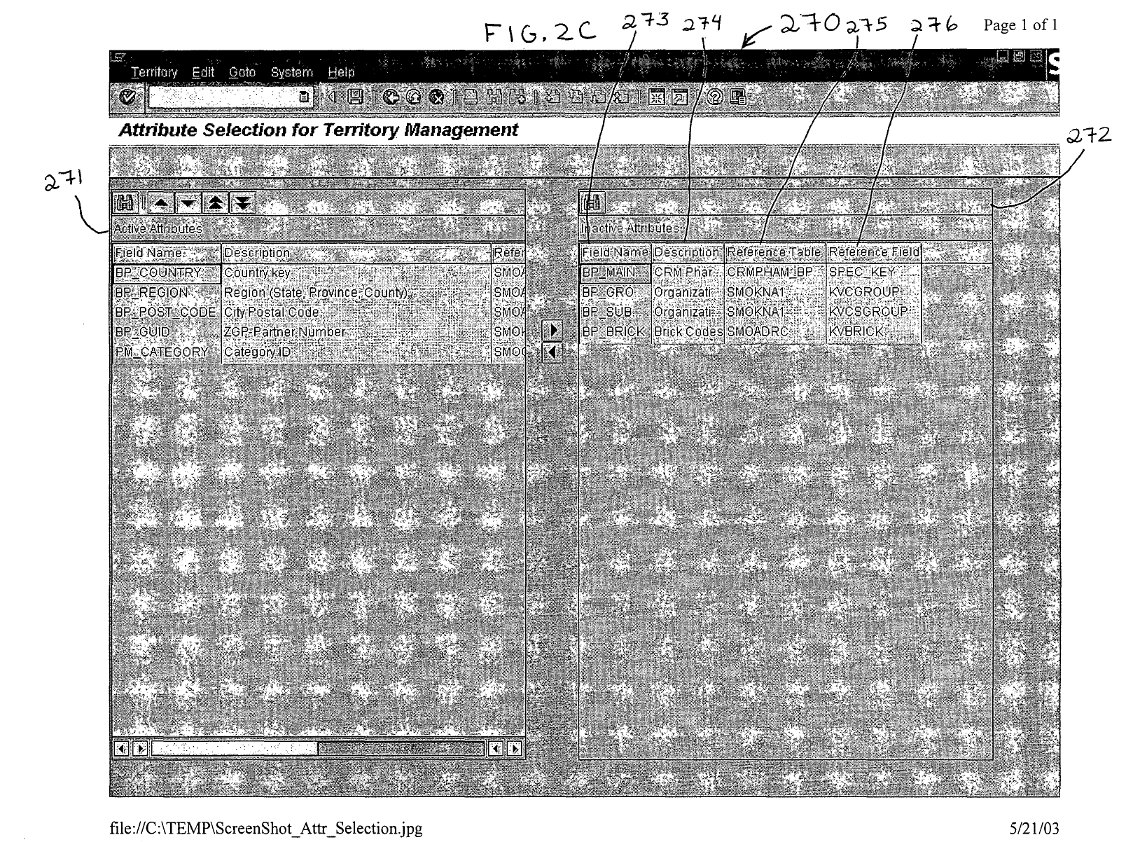

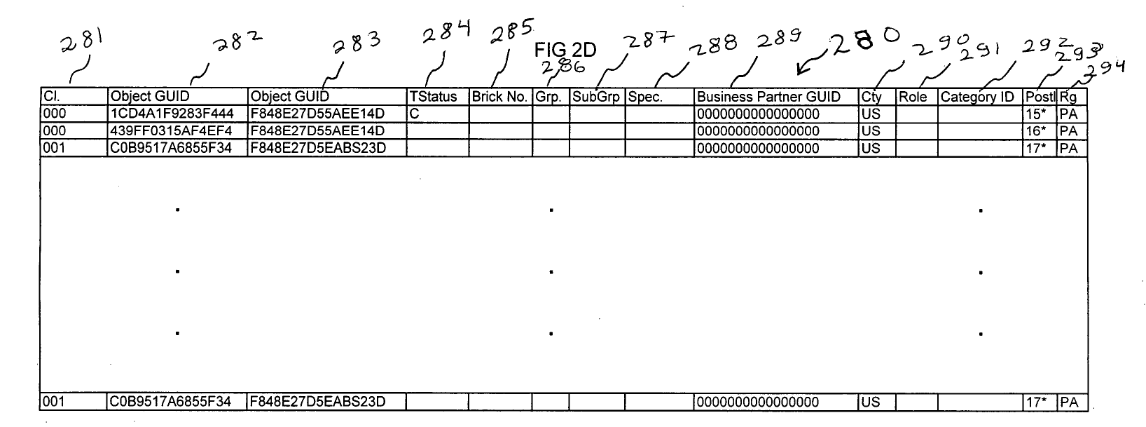

FIG. 2 shows a conceptual representation of a hierarchy 200 of territory objects 202a-g, as might be contained in hierarchy 56, in accordance with embodiments of the present invention. In this example, territory objects 202 may represent “work units” within a company and may correspond to a diverse range of entities such as business units, geographical areas, product lines, or sales groups, to list just a few examples. In the FIG. 2 representation, the territory objects 202 are shown to be associated with one another by connecting lines between the territory objects 202.

In an embodiment of the invention, territory object 202a may represent a “General Sales Management” group, for example. The General Sales Management group may have responsibility for all sales activities within a company, for example. Territory objects 202b and 202c, representing “Product Line B” and “Product Line A,” respectively, may be associated with the General Sales Management object 202a. Objects 202b and 202c each may represent product lines that the General Sales Management Group is responsible for, and each can be referred to as child nodes of a parent node (object 202a in this example). A child node may be a node at a lower level in the hierarchy 200, as compared to the higher node (i.e., parent node).

In this example, territory objects 202d and 202e may represent sales offices in Texas and Pennsylvania, respectively, and may be associated with Product Line A (object 202c). The sales offices (e.g., objects 202d and 202e) may be headquarters for sales activities involving Product Line A. In this example, the Product Line A object 202c is the parent node to the sales office objects 202d and 202e, which are child nodes. Thus, object 202c is both a parent node and a child node. In other words, the object 202c may be a child with respect to object 202a and may be a parent with respect to objects 202d and 202e.

Referring again to FIG. 2, object 202e may have two child objects, for example, “Sales Group North” object 202f and a “Sales Group South” object 202g. In this example, the Sales Group North object 202f may represent a group of salespeople that are based out of the Pennsylvania sales office 202e and are responsible for covering the northern part of the state. Conversely, the Sales Group South object 202g may represent a group of salespeople that are based out of the Pennsylvania sales office 202e and are responsible for covering the southern part of the state, for example.

In this example, territory objects 202f and 202g may be referred to as leaf nodes since no child object is associated with the territory objects 202f and 202g. In embodiments of the present invention, it is possible for territory objects to have multiple parent objects. For example, if the Texas sales office also sells product line B, object 202d (Sales Office TX) would then also be associated with object 202b. For example, a phantom line is shown in FIG. 2 connecting the two objects 202b and 202d.

In embodiments of the present invention, leaf nodes or territory objects may be associated with attributes that describe a responsibility for the territory object. For example, attributes may provide information relating to the territory object they are associated with. A list of potential attributes can include a country (e.g., the country of a business partner address); region (e.g., state, province, county, etc.; zip code); category (e.g., a product category ID); group such as a business partner group (e.g. hospitals); a more detailed specialization of the group (e.g., sub group); brick (e.g., a geographic area where a business partner is located); specialization (e.g. an internist); and GUID (e.g., a business partner global unique identifier). Additional attributes may be used, such as transactional data describing the net value of a transaction, business partner numbers, characteristics of the business partner (e.g., industry sector, products, identifiers, etc.) business partner roles, and/or any other type of attribute. In embodiments of the invention user definable attributes may be created by users.

Referring again to FIG. 2, the Sales Group South territory object 202g may have two attributes 204a and 204b, depicted in FIG. 2 as hexagons, associated with it. When a territory object has more than one attribute associated with it, those attributes may be stored in form of a vector of attributes for the territory object.

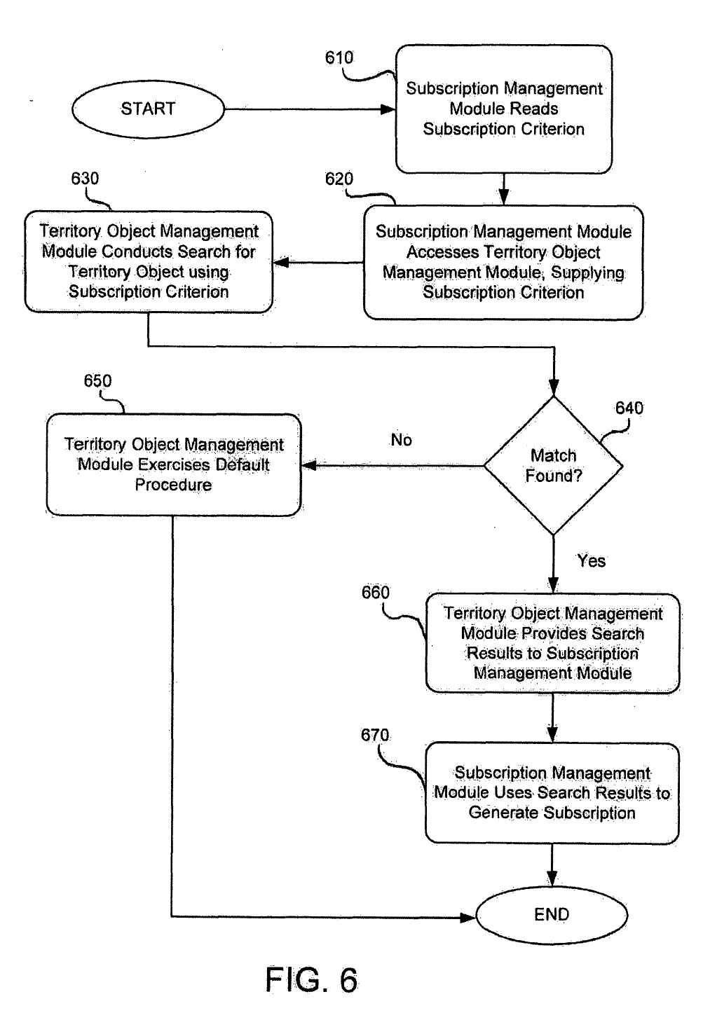

In embodiments of the invention, attributes at leaf nodes or territory objects may need to be maintained, simplifying the maintenance required. At higher nodes in the hierarchy 200, the attributes of the higher node's child nodes can be aggregated. That is, the attributes of lower-level territories can automatically be associated with their respective parent nodes. In the FIG. 2 example, attributes 204a and 204b are aggregated at territory object 202e because they are associated with a child node of object 202e (e.g., territory object 204g—Sales Group South). This aggregation of attributes at higher nodes in the hierarchy becomes relevant when identifying territories for subscription assignments, and will be described below in connection with FIG. 6.

In embodiments of the present invention, individual territory objects, for example, territory objects 202f and/or 202g may have validity data associated with each object. The validity data may define a time dependency for, for example, the description of each territory, the values of associated attributes, and/or the parent relationship of the territory object. In this example, the validity data may be associated with territory objects so that the territory objects can be flexibly defined and can be reassigned without losing past information. It is recognized that validity data may also be associated with attributes such as attributes 204a and 204b.

As an example, a territory may have two attributes such as country and region. For example, the country may be defined as “U.S.A.” and the region may be defined as “Florida,” “Georgia” and “Alabama.” The description for this territory may be “Sales Group South.” Because of a reorganization, this territory may be modified and get an additional region (e.g., South Carolina) in its responsibility and a new name “Sales Group Big South.” In this example, this territory object may get an additional validity, with changed description and/or attributes. For example, the country will remain as the U.S.A., however the region may include “Florida,” “Georgia,” “Alabama” and “South Carolina.” Thus a validity or validity data associated with a territory may define, for example, a length of time during with data associated with the territory is valid. Thus, validity data may be used to conveniently modify the territory and/or associated information. As such, the determination of commissions, for example, may be accomplished easier in situations where different employees have responsibility for a territory at different times. It is recognized that in embodiments of the present invention, validity data may be associated with the territory objects themselves.

In another example, the assignment of a salesperson to a specific territory object may be accomplished via her position within the sales organization. Suppose now one salesperson intends to take a one month leave of absence. In this case, validity data may be used to de-activate the sales person taking the leave and to activate a substitute salesperson for that period of time. In embodiments of the invention, this configuration may permit efficient access to statistics based on the changing information. For example, commissions or other statistics may be determined separately for the various salespersons.

In embodiments of the present invention, the structure of territory objects in hierarchical levels can be set up in a customization table. The customization table may specify the territory object identifier and/or the relevant parent territory object for each territory object in the hierarchy, as well as any attributes associated with the territory object. The characteristics of the hierarchy of nodes may be defined in the customization table. The customization table may specify the number of territory levels within the hierarchy, and may be stored in the territory object management module 55 (FIG. 1), for example. The customization table may include hierarchy codes that may identify the associated information. For example, hierarchy code “00” may indicate the name of the company, “01” may identify product line, “02” may *indicate region, “03” may indicate sales area, etc.

It is recognized that Interfaces to external tools such as a spreadsheet or the like are possible so that tables may be imported and/or exported. Because territory objects are flexible and can relate to entities other than geographic indicators (a product line for example), territories can be shuffled around within the hierarchy.

FIG. 2A shows an example display 220 that may be presented to a user of a territory management application program, for example on screen 18 shown in FIG. 1. In this example, a user may be using the program to review information on a particular sales territory such as the hierarchy 200 of the territory shown in FIG. 2.

A structure area 222 near the left side of display 220 visually conveys hierarchy structural information by listing territory object identifiers and descriptions (hereinafter collectively referred to as labels) on lines within the area 222, indenting child territory object labels from the labels of the parent territory object labels. Structure area 222 shows the name of the territory object 202a called “General Sales Management” listed as label 224 on the first line. Below the group label 224, object 202c representing “Product Line A” may be listed as label 226 and object 202b representing “Product Line B” may be listed as label 234. As shown, these labels may be indented, indicating that they correspond to child territory objects of object 224.

As shown in FIG. 2A, territory objects 202d and 202e may be listed as labels 232 and 228 in area 222, respectively. These labels 232 and 228 may correspond to the sales offices associated with the product line object 202c, for example. The object 202b may be associated with a sales office listed as label 236, for example, a sales office in Florida (FL). Under the sales office label 228 in display 220, objects 202f and 202g may be represented as label 230 which may include the “Sales Group North” (e.g., object 202f) and 231 which may include “Sales Group South” (e.g., object 202g). These areas may be indented below region 228. As shown in FIG. 2A, label 230 is highlighted indicating that the user has selected it, for example, by using an input device 14 (FIG. 1).

In an embodiment of the invention, an object description area 239, to the right of the structure area 222, may describe the selected territory object details. Thus, if the user has highlighted label 230 in area 222, then corresponding details may be shown in area 239. The territory level section 240 may indicate that the selected territory object is an Area. Additionally or optionally, the territory level section 240 may include a pull down menu to select other territory levels such as product lines, sales groups, etc. As shown in area 239 of display 220, Territory ID and Territory Description fields 241 and 242, respectively, display the corresponding values for the selected object (e.g., R1010001 and Sales Group South). Also, the Higher-Level TerritoryID field 243 lists the Territory ID (R101) of parent territory object, corresponding to label 228. Section 244 may include a combined ID (e.g., RR1R101R1010001) for the selected object, for example, this ID may include an identifier from label 224 (e.g., R), an identifier from label 226 (e.g., R1), an identifier from label 228 (e.g., R101) and finally an identifier from the selected object label 230 (e.g., R1010001).

A validity area 245 may include validity data may specify dates during which the corresponding territory is valid with “Valid From/Valid To” fields. The validity data may relate to the territory object's description, the values of associated attributes, and/or its position within the hierarchy. The validity area 245 may include a navigation toolbar to the right of validity fields that may be used to change dates and/or otherwise manage different validities or validity data for a territory. By selecting buttons from the navigation toolbar, a user can create a new validity data, scroll to the next or previous validity data for the selected territory, and jump to the first or last validity data for the territory. It is recognized that the user could display information on another territory in description area 239 by selecting an alternate territory label within structure area 222.

A employee area 246 may identify on or more employees or salesperson or people that may be responsible for the associated territory. The employee area 246 may include employee identification numbers, names, start and end dates, positions, and/or any other information related to the employee.

An attribute area 249 may include a list of the attributes associated with the selected territory object, and is located below the employee area 246. Attribute values corresponding to, for example, a country, region, postal code, or other attributes may be shown in an attribute table 249. The attribute table 249 may include attribute descriptions and corresponding attribute values. Additional attributes may include attributes for business partners, category IDs, etc. It is also possible for a user to specify and/or define a new category of attributes and/or include additional attributes in the table 249. Like the description area 239 above it, attribute area 249 as well as employee area 246 can be updated to reflect the currently selected territory object label in structure area 222, and may permits the user to view and/or update fields located therein if desired.

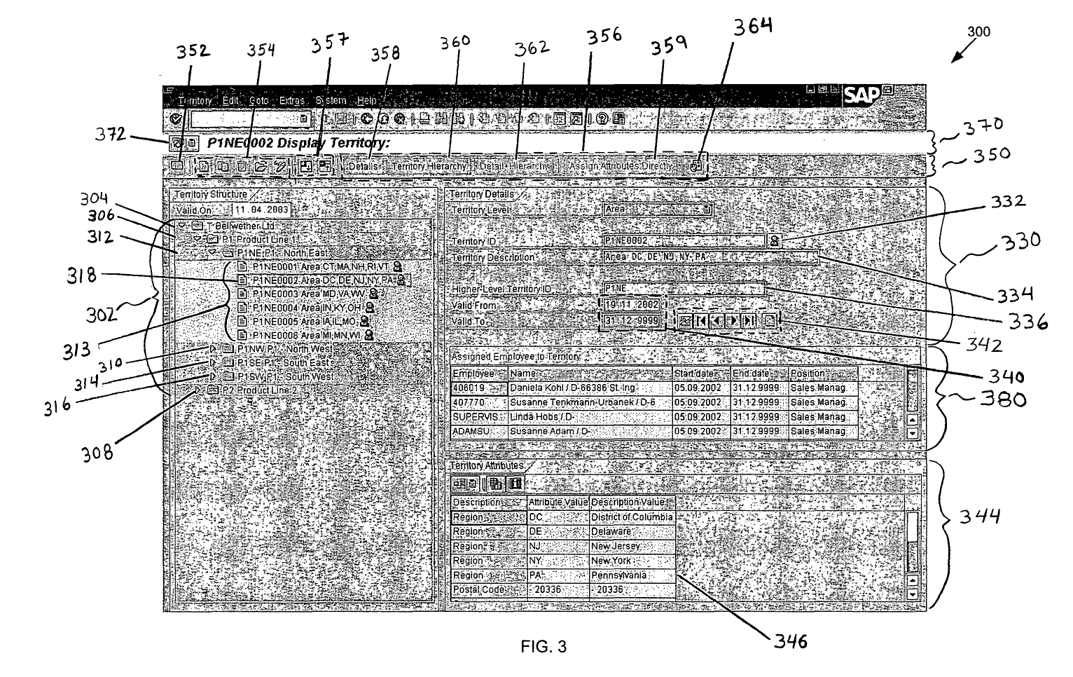

Additional functions such as toolbar functions, etc. that may be possible via display 220 are described in more detail in the description below with respect to FIG. 3.

FIG. 2B shows an example of a customization table 250 in accordance with an embodiment of the present invention. A user may define and/or describe a plurality of levels included in the hierarchy of territory objects using, for example, table 250, in accordance with embodiments of the present invention. The table 250 may include a column 252 to define a “Level” and a column 255 to define a corresponding “Description” for the corresponding level. Entry 256 may indicate the root level 0 that may be, for example, the name of the company. The next level down, for example, level 1 may be indicated by entry 257 that may represent a product line, for example. The regions may be represented by level 2 as indicated by entry 258 and the area may be represented by level 3 as indicated by entry 259. It is recognized that a user can freely describe the various levels, can define additional levels, can delete levels, and/or customize the table 250 in any desirable way.

FIG. 2C shows an exemplary attribute table 270 in accordance with embodiments of the present invention. The attribute table 270 may include a set of possible attributes that may be selected by the user. It is recognized that user can define additional attributes then the ones shown in table 270 or can delete attributes as desired, for example. Table 270 may include an active attribute section 271 that may include one or more active attributes. The table 270 may also include an inactive attributes section 272 that may include one or more inactive attributes. The attribute sections 271 and 272 may include columns for field names 273, field description 274, reference table 275, reference field 276, and/or other columns for additional information. As listed in the table 270, fields may include business partner (BP) country name, BP region, BP postal code, BP global unit ID (GUID), product master (PM) category, and/or other classification information related to the business partner. For example, this could be specific to the business of the business partner.

FIG. 2D is a spreadsheet 280 or table including data associated with embodiments of the. In this example, spreadsheet 280 includes values for attributes that are active in section 271 of attribute table 270. Values for inactive attributes (e.g., attributes in section 272 of attribute table) may be left blank in spreadsheet 280. The spreadsheet 280 may be stored in one or more of the databases in this system, in accordance with embodiments of the present invention. In an embodiment of the present invention, spreadsheet 280 may be configured in a flat structure. Accordingly, embodiments of the present invention may provide faster searching capabilities since data related to the various territories may be stored in a single table that is configured in the flat structure. Thus, only a single table may need to be searched using one select search criteria. For example, when searching for a territory by product, the product's name may be used to search the entire hierarchical relationship.

As shown in FIG. 2D, spreadsheet 280 may include client ID 281, object global unit, IDs (GUID) 282 and 283, object status 284, brick number 285, group no. 286, sub-group no. 287, specification 288, business partner GUID 289, country 290, role 291, category 292, postal code 293 and region 294. Of course, client ID may be specific to a particular client. It is recognized that a single computer system may be used to run one or more territory management tools for different clients that may be differentiated by for example, the client ID 281. GUID 282 may be used as technical index for the table entry. GUID 283 may be used as a technical index to the validity data. Entry 284 may include the object status such as expired (E), changed (C), distributed (D), and unassigned (U).

Entries 285, 286, 286, and 288 may be related to the business of the BP and/or to the classification of the business partner. As indicated above, these entries may not contain a value since these attributes were not selected by the user to be active, in table 270, for example. Entries in column 289 may include a business partner GUID that be used as a key or index to represent the business partner. Entries in column 290 may specify the country related to the business partner. Entries in column 291 may indicate a business partner role and entries in column 292 may represent a business partner ID, product ID, and/or object ID, for example. Entries in column 293 may represent the postal code while entries in column 294 may represent the region of the business partner and/or the associated object, for example.

FIG. 3 shows an example display 300 that may,be presented to a user of a territory management application program, for example on screen 18 shown in FIG. 1. In, this example, a user may be using the program to review information on a particular sales territory. The user may be interested in updating information in the territory object that corresponds to the particular sales territory, for example.

A structure area 302 near the left side of display 300 visually conveys hierarchy structural information by listing territory object identifiers and descriptions (hereinafter collectively referred to as labels) on lines within the area 302, indenting child territory object labels from the labels of the parent territory object labels. Structure area 302 shows a name of a company “Bellwether Ltd.” label 304 on the first line. The company may be the corporation that employs the user, for example. Below the company label 304, “P1 Product Line 1” 306 and “P2 Product Line 2” 308 labels are indented, indicating that they correspond to child territory objects of object 304. Similar to the FIG. 2 example, labels 306 and 308 may correspond to product lines sold by C Company.

As shown in FIG. 3, territory object labels 310, 312, 314, and 316 respectively correspond to a northwestern sales region (P1NW North West 310), a northeastern sales region (P1NE Northeast 312), a southeastern sales region (P1SE South East 314), and a southwestern sales region (P1SW South West 316), and are indented below label 306. These labels 310, 312, 314 and 316 inform the user that the sales market for product Line 1 is divided into four geographic regions. For example, the northeast region has a section dedicated to a plurality of geographic areas 313. Each area may include one or more states or regions in the associated country. In this case, there may be 6 areas (e.g., P1NE0001-P1NE0006). These areas may be indented below region 312. As shown in FIG. 3, label 318 is highlighted, indicating that the user has selected it, for example, by using an input device 14 (FIG. 1).

In an embodiment of the invention, an object description area 330, to the right of the structure area 302, may describe the selected territory object. Territory ID and Territory Description fields 332 and 334 display the appropriate values (P1NE0002, and DC, DE, NJ, NY, PA), and a Higher-Level TerritoryID field 336 lists the Territory ID (P1NE) of parent territory object, corresponding to label 312. A validity area including validity data shows elements 340 and 342 may specify dates during which the corresponding territory is valid with “Valid From/Valid To” fields 340. The validity data may relate to the territory object's description, the values of associated attributes, and/or its position within the hierarchy. In this example, the territory is valid from Nov. 19, 2002 until Dec. 31, 9999, a shorthand notation to indicate that the territory is valid indefinitely from Aug. 6, 2002 onward. A navigation toolbar 342 to the right of validity fields 340 helps to manage different validities or validity data for a territory. By selecting buttons from the navigation toolbar 342, a user can create a new validity data, scroll to the next or previous validity data for the selected territory, and jump to the first or last validity data for the territory. The user could display information on another territory in description area 330 by selecting an alternate territory label within structure area 302.

A employee area 380 may identify a plurality of employees or salespeople that may be responsible for the associated territory. The employee area 380 may include employee identification numbers, names, start and end dates, positions, and/or any other information related to the employee.

An attribute area 344 lists the attributes associated with the selected territory object, and is located below the employee area 380. Attribute values corresponding to the plurality of regions (DC, DE, NJ, NY, PA, etc.) are shown in an attribute table 346. The attribute table 346 may include attribute descriptions and corresponding attribute values. Addition attributes may include attributes for postal code, business partner, category ID, etc. It is also possible for a user to specify and/or define a new category of attributes and/or include additional attributes in the table 346. Like the description area 330 above it, attribute area 344 as well as employee area 380 can be updated to reflect the currently selected territory object label in structure area 302, and permits the user to view and/or update fields located therein if desired.

A toolbar 350 is located above structure area 302 and description area 330. A “Locator” button 352 near the left edge of toolbar 350 can initiate a territory object search when selected by a user. Territory objects may be searched for by description, by territory level within the hierarchy, or by attributes. A group of buttons 354 to the right of Locator button 352 permit a user to create a new territory, copy a territory, read a territory object from a database, and toggle a dialog mode. Button group 357 may be used to expand and/or contract a territory and/or other listing.

In an embodiment of the present invention, a group of buttons 356 may allow a user to select different views among structure area 302, description area 330, and attribute area 344. A “Details” button 358 causes the description and attribute areas 330 and 344 to be expanded in size, while hiding the structure area 302, when selected. This view may be appropriate when a user is interested in the details of one territory object, and less concerned about the hierarchy structure. Similarly, a “Territory Hierarchy” button 360 causes the structure area 302 to be expanded in size, while hiding the description and attribute areas 330 and 344, when selected. This view may be appropriate when a user is primarily interested in the structural details of the hierarchy.

A “Details +Hierarchy” button 362 causes each of the three areas 302, 330, and 344 to be displayed, and is the currently selected view in the FIG. 3 display 300. An “Assign Attributes Directly” button 359 may permit a user to assign attributes, for example, in table 346 of section 344. A “Personalization” button 364 permits the user to customize views and processing modes by saving personal settings for later recall. A title row 370 is located above the toolbar 350. The title row 370 contains a display title 372 (“Display Territory P1NE0002” in this example) near its left side. Title row 370 may also show the current dialog mode (e.g., display, change, create) and/or the territory ID of the currently selected territory.

It is recognized that the configuration of display 300 for the territory management application program, in accordance with embodiments of the present invention, is given by example only and that display 300 can be configured in any way desirable to display other information, features, selections, links, etc.

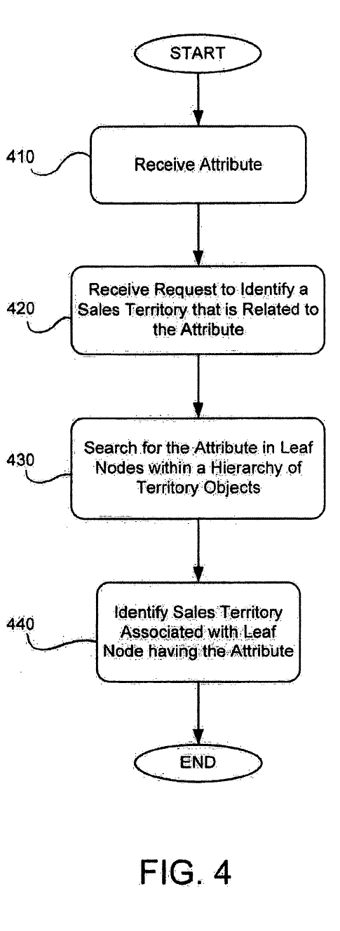

Referring to the flowchart of FIG. 4, the process performed by a processor executing instructions from a territory management application program begins, at box 410, with the receipt of a territory attribute. The attribute may be entered by a user using an input device 14 (FIG. 1), such as a keyboard, mouse, or stylus, for example. Next, at box 420, an input requesting the identification of a sales territory that is related to the attribute is received. This may prompt the execution of a search for the attribute among attributes associated with leaf node territory objects within a hierarchy of territory objects, as shown in box 430. Examples of user inputs that may be received include the click of a mouse button, the typing of a key or sequence of keys on the keyboard (a carriage return, for example), a predetermined period of inactivity after receiving data in an input field, a voice-activated command input, the touch of a touch pad screen, etc.

Because attributes are associated with territory objects, these attributes may act as filters on the associated objects during the search process. Moreover, because all attribute values can be stored in a single data table, efficient searching can be performed without first having to inherit attributes at leaf node territory objects from higher node territory objects. This may increase the speed at which searches may be performed. By facilitating faster searches, the invention may make territory management solutions with a great number of territories more practicable. Furthermore, storing attributes in a single table enables searching on a single select statement, such as the specification of an attribute. Referring again to FIG. 4, at box 440 a sales territory corresponding to a territory object or leaf node that is associated with the attribute is identified.

In embodiments of the present invention, multiple attributes may be received at box 410. Various logical operators such as logical AND, logical OR, logical NAND, and logical NOR may combine the multiple attributes.

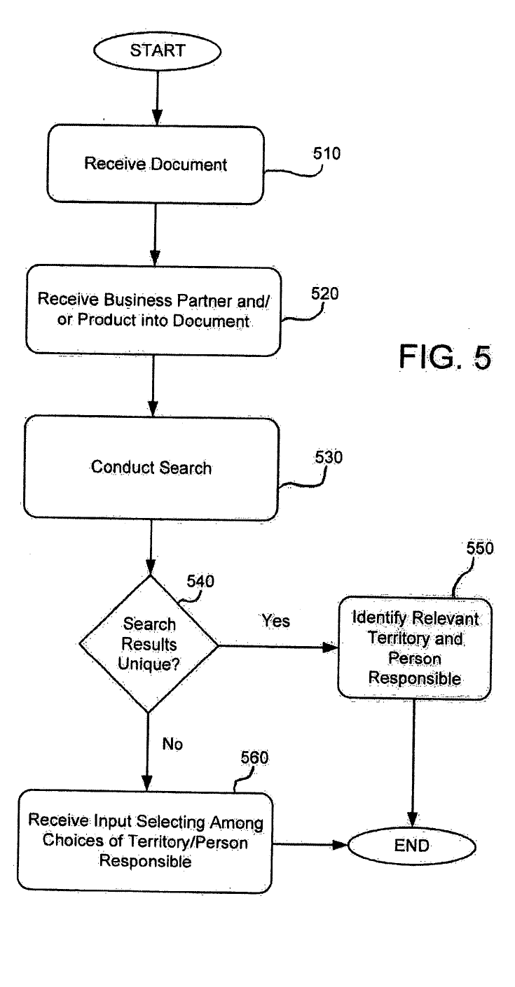

As another example, embodiments of an inventive system may be used to associate files in an organization with the responsible employee(s) or other individuals. Suppose a user is creating a document such as a sales order. The user does not know the identity of the salesperson responsible for making the sale. She does know, however, the identity of the business partner purchasing the sale product and/or the product type itself. The flowchart of FIG. 5 details the process that may be performed by a processor executing instructions from a territory management application program.

The process begins, at box 510, with the reception of the sales order document. Receiving the document in box 510 may, for example, comprise accessing an existing document or creating a new document. Next, at box 520, the system may receive the business partner and/or the product information from the user into the document, for example, from an input device 14 (FIG. 1), such as a keyboard. The system, in box 530, may conduct a search. The system may, for example, map attributes of the business partner and/or the product into a search structure. If the search results are unique, at box 540, the system identifies the relevant territory and the responsible salesperson (550) and the process ends. If, at box 540, the search results are not unique, the system may receive input from the user selecting from a list of possible choices for the territory/responsible salesperson, as shown in box 560.

A territory management system can also be used for sales planning, time-dependent organizational restructuring, determining which business partners belong to a given territory and/or which products can be promoted in a given territory, and assigning sales territories to employees, for example. As further examples, a territory management system may be capable of determining bases for commission, bases for data distribution, bases for authorizations, bases for campaigns, and determination of responsibility.

Companies with remotely located sales employees that use a distributed network need an efficient method of distributing information to the employees. It is desirable that each employee receives information related to her practice. It may be desirable to limit unnecessary information from reaching them to avoid compromising confidentiality and to eliminate the waste of time and network resources, for example. This endeavor may be complicated when sales territories or territory responsibilities are reallocated, when new sales products are launched/discontinued, when sales offices expand or merge to cover new sales territories, and/or when sales employees transfer to another sales office or location. The territory object management module 55 (FIG. 1) can be used in conjunction with the subscription management module 66 (FIG. 1) to assign subscriptions to replication objects, such as publications, for delivery to mobile client sites such as sites 10, 60, and 62 (FIG. 1). Subscriptions can be used to determine the proper distribution of data to sites, and the assignment of a subscription can trigger the distribution of data to the site.

Referring to the flowchart of FIG. 6, the process performed by a processor executing instructions begins, at box 610, with the subscription management module reading a subscription criterion. The subscription criterion may be identified using a rule for replication of a publication. For example, it may be determined whether the publication is associated with a product type, geographic region, sales group, sales office, subject matter area, etc. The subscription criterion can be stored together with the publication or separately.

Next, at box 620 the subscription management module accesses the territory object management module and supplies the subscription criterion. This may be facilitated through an interface between the subscription management module and the territory object management module. The interface may use dynamic table mapping to link data tables in each module using one or more fields.

The territory object management module may conduct a search for a territory object, as shown in box 630, searching the hierarchy of territory objects for the supplied search criterion. With reference to FIG. 2, the territory object management module may search the leaf nodes 202f and 202g for the presence of subscription criterion in attributes 204a and 204b. If a match has been found at box 640, the territory object management module provides the search results (the territory, employee, business unit, etc., corresponding to an identified territory object) to the subscription management module, as shown in step 660. The subscription management module may use the search results to generate a subscription, as shown in box 670. The subscription management module may use the generated subscription to distribute the publication in the network. A failure to find a match at box 640 may cause the territory object management module to exercise a default procedure such as sending an error message to the subscription management module, as shown in box 650.

Because the territory object management module can derive appropriate sites for subscriptions to replication objects, the subscription management module may not likewise maintain this information, which may reduce the amount of storage and maintenance activity required. Default subscriptions for newly created employees and time-dependent subscriptions are also possible.

While examples discussed above have focused on searching for territory objects using attributes or subscription criterion, searches may also be executed according to a territory object's level within the hierarchy of territory objects, or according to the description of a territory object. An example of a territory object description 334 is shown in FIG. 3. Aspects of the invention can also be used for dividing a sales market into sales territories, and assigning these territories to field sales employees, including adapting and reorganizing a territory structure and its assignment.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of managing a plurality of sales territories, the method comprising:
associating leaf nodes with sales territories such that each leaf node is associated with one of the sales territories, the leaf nodes being located in a hierarchy of nodes, wherein each higher node in the hierarchy is associated with at least one of the leaf nodes and represents the sales territory of such leaf node;
associating a first attribute with a first one of the leaf nodes, the first attribute relating to the sales territory that is associated with the first leaf node;
receiving a second attribute and a request to identify a sales territory that is associated with the second attribute and searching the leaf nodes for the second attribute without inheriting attributes from the higher nodes in the hierarchy; and
identifying the sales territory associated with a leaf node having the second attribute.

2. The method of claim 1, further comprises:
associating a plurality of attributes with the first leaf node.

3. The method of claim 2, further comprises:
storing the plurality of attributes as a vector.

4. The method of claim 3, further comprises:
storing vectors associated with a plurality of leaf nodes in a single data table.

5. The method of claim 1, further comprises:
associating attributes with those leaf nodes with which one of the higher nodes is associated, and aggregating those attributes at the higher node.

6. The method of claim 1, further comprises:
defining a new category of attributes that can be associated with the leaf nodes.

7. The method of claim 1, further comprises:
assigning a sales territory to an employee.

8. The method of claim 1, wherein a characteristic of the hierarchy of nodes is defined in a customization table.

9. The method of claim 8, wherein the customization table includes a number of levels in the hierarchy.

10. The method of claim 8, wherein the customization table includes a name for each level in the hierarchy.

11. The method of claim 1, further comprising associating validity data with a node.

12. The method of claim 1, wherein the leaf node has more than one parent node in the hierarchy of nodes.

13. The method of claim 1, further comprises:
receiving a third attribute, wherein the request comprises identifying a sales territory that is associated with at least one of the second and third attributes.

14. A machine-readable medium having stored thereon a plurality of executable instructions to be executed by a processor to implement a method for managing a plurality of sales territories, the method comprising:
associating leaf nodes with sales territories such that each leaf node is associated with one of the sales territories, the leaf nodes being located in a hierarchy of nodes, wherein each higher node in the hierarchy is associated with at least one of the leaf nodes and represents the sales territory of such leaf node;
associating a first attribute with a first one of the leaf nodes, the first attribute relating to the sales territory that is associated with the first leaf node;
receiving a second attribute and a request to identify a sales territory that is associated with the second attribute and searches the leaf nodes for the second attribute without inheriting attributes from the higher nodes in the hierarchy; and
identifying the sales territory associated with a leaf node having the second attribute.

15. The machine-readable medium of claim 14, further comprises:
instructions that when executed associate a plurality of attributes with the first leaf node.

16. The machine-readable medium of claim 15, wherein the plurality of attributes is stored as a vector.

17. The machine-readable medium of claim 16, wherein vectors associated with a plurality of leaf nodes are stored in a single data table.

18. The machine-readable medium of claim 14, further comprises:
instructions that when executed associate attributes with those leaf nodes with which one of the higher nodes is associated, and aggregate those attributes at the higher node.

19. The machine-readable medium of claim 14, wherein a user can define a new category of attributes that can be associated with the leaf nodes.

20. The machine-readable medium of claim 14, further comprises:
instructions that when executed assign a sales territory to an employee.

21. The machine-readable medium of claim 14, wherein validity data is associated with a node.

22. The machine-readable medium of claim 14, wherein first and second higher nodes are associated with a leaf node, and wherein the first and second higher nodes are not associated with one another.

23. A sales territory management system comprising machine-readable medium comprising:
data structures comprising a plurality of territory objects representing sales territories, each territory object having associated with it an attribute relating to the sales territory that the object represents, wherein validity data is associated with a territory object of the plurality of territory objects; and
program instructions comprising a territory object management module that, when executed by a processor, reads the validity data and manages each territory object according to the validity data for the territory object.

24. The sales territory management system of claim 23, wherein the validity data indicates a time period when the territory object is active.

25. The sales territory management system of claim 23, wherein the validity data can be changed by a user.

26. The sales territory management system of claim 23, wherein the territory object management module reorganizes the territory objects following a validity data change.

27. The sales territory management system of claim 26, wherein the territory object management module generates additional territory objects.

28. The sales territory management system of claim 23, further comprises:
a validity data set comprising a plurality of validity data, the validity data set being associated with the territory object.

29. A method of generating subscriptions in a computer network, the method comprising:
reading a subscription criterion for a replication object to be replicated in a computer network, the subscription criterion indicating that the replication object will be replicated to sites in the network that subscribe to the subscription criterion;
accessing a territory object management module having access to a hierarchy of territory objects to identify a territory object that is associated with the subscription criterion; and generating a subscription for the replication object using the territory object.

30. The method of claim 29, further comprises:
associating the territory object with a sales region.

31. The method of claim 29, wherein the subscription criterion corresponds to a defined attribute, the attribute is associated with the territory object.

32. The method of claim 29, wherein identifying the territory object comprises searching a data table using the subscription criterion, the data table containing attributes that are associated with the territory objects.

33. The method of claim 29, wherein the replication object is defined by a publication.

34. The method of claim 29, wherein the subscription criterion is defined by a publication.

35. The method of claim 29, further comprises:
reading a second subscription criterion for the replication object to identify a territory object that is associated with at least one of the subscription criterion.

36. A computer network comprising:
a plurality of client devices connected to a server device, each client device being capable of having a subscription criterion assigned to it, the subscription criterion indicating that the client device subscribes to objects from the server device that have the subscription criterion;
data structures comprising a territory object management module having access to a hierarchy of territory objects, which territory object management module, when executed by a processor, is capable of identifying a territory object having a specified sales territory attribute; and
data structures comprising a subscription management module that, when executed by a processor, reads a subscription criterion of a replication object to be replicated by the server device and generates a subscription for the replication object;
wherein the territory object management module and the subscription management module are interfaced such that the territory object management module identifies a territory object having the subscription criterion as a sales territory attribute, and wherein the subscription management module uses the identified territory object to generate the subscription for the replication object.

37. The computer network of claim 36, the subscription criterion corresponds to a defined attribute, the attribute is associated with the territory object.

38. The computer network of claim 36, wherein the interfacing comprises a first data table stored in the subscription management module being mapped with a second data table stored in the territory object management module.

39. The computer network of claim 36, wherein the replication object is a publication.

40. The computer network of claim 36, wherein the subscription criterion is defined by a publication.

41. A method comprising:
structuring a plurality of nodes in a plurality of hierarchical levels, wherein a higher level node is a parent of a lower level child node;
assigning an attribute to a node from the plurality of nodes;
assigning validity units to the node from the plurality of nodes, the node is active based on contents of the validity units;
creating a table containing a node identifier for each node from the plurality of nodes and the corresponding attribute for each node;
receiving a request based on a requested node identifier or a requested attribute;
searching the table based on the request; and
if a match is found, providing information associated with the match from the table.

42. The method of claim 40, wherein the attribute is a country, a region, a postal code, business partner or a product category identifier.

43. The method of claim 42, further comprises:
associating a plurality of attributes with the node from the plurality of nodes.

44. The method of claim 40, further comprising:
associating the node with a sales territory.

45. The method of claim 44, further comprising:
assigning the sales territory to a position of an employee.

46. The method of claim 40, further comprising:
assigning more than one higher level parent node to the lower level child.

47. The method of claim 40, further comprising:
aggregating the attribute of a lower level child node to its corresponding higher level parent node.

48. The method of claim 40, further comprising:
assigning a duration value to the validity data, wherein the duration value indicates a time period during which the value of the node is active.

49. The method of claim 48, wherein the node is inactive outside the duration value.

50. The method of claim 40, wherein during the search based on the request, the attribute from the higher level parent node is not inherited by the lower level child node.
